(19) United States
(12) Patent Application Publication
(10) Pub. No.: US 2024/0106255 A1
(43) Pub. Date: Mar. 28, 2024

(54) ELECTRONIC DEVICE FOR CHARGING SERVICE USE DEVICE, AND OPERATION METHOD THEREFOR

(71) Applicant: Samsung Electronics Co., Ltd., Suwon-si (KR)

(72) Inventors: Yangdon LEE, Suwon-si (KR); Taejun KWON, Suwon-si (KR)

(73) Assignee: Samsung Electronics Co., Ltd., Suwon-si (KR)

(21) Appl. No.: 18/526,470

(22) Filed: Dec. 1, 2023

Related U.S. Application Data
(63) Continuation of application No. PCT/KR2022/006566, filed on May 9, 2022.

(30) Foreign Application Priority Data
Jun. 8, 2021 (KR) 10-2021-0074311

(51) Int. Cl. H02J 7/00

(52) U.S. Cl. CPC H02J 7/0071; H02J 7/00034; H02J 7/0013; H02J 7/0048; H02J 7/00712; H02J 2310/14; H02J 2310/70

(57) ABSTRACT

Provided is an electronic device configured to charge at least one charging service use device and an operating method thereof. An embodiment of the present disclosure provides an electronic device configured to receive charging state information including at least one of device identification information, charging specifications, a current remaining battery capacity, and an expected discharge time from at least one charging service use device, generate a charging schedule for charging the at least one charging service use device based on a remaining capacity of a built-in battery and the received charging state information, move to a location of a charging target device determined based on the charging schedule, and supply power stored in the built-in battery to the charging target device by connecting to a charging terminal of the charging target device to charge the charging target device.

### TECHNICAL FIELD

The present disclosure relates to an electronic device configured to charge a charging service use device and an operating method thereof. More specifically, the present disclosure relates to an electronic device including a built-in battery and configured to supply charging power to home appliances using a charging service.

### BACKGROUND ART

Recently, according to the growth of the battery industry, the unit cost of production of batteries has been lowered, and as the discharge efficiency has improved, home appliances that include built-in batteries have become widespread. For example, home appliances including a battery and receiving operating power from the battery, such as a wireless cleaner, a wireless fan, a wireless LED light, a wireless speaker, etc. have become widely used.

To charge a built-in battery of a home appliance, a charging station that provides a charging function through docking is used, or a method of receiving charging power through a wall power outlet by using a charging device (e.g., a charging adaptor) is employed. When using a charging station for charging, a user docks home appliances onto the charging station when not in use, and then detaches and operates the home appliance by using the power stored in the built-in battery. As for the charging method using a charging station, although mobility during use is secured with the utilization of a battery, as the charging station still needs to use a power source buried in a wall, there are limits to determining an installation place. Moreover, as a wall power outlet is required, home appliances need to be moved for charging after using them. This may cause inconvenience, and the complex wiring may ruin the aesthetic view of an interior space. As the charging station needs to be connected to a wall power outlet, electric wires or a power strip is required, which may be a factor in deteriorating user convenience and spoiling interior aesthetics.

When charging home appliances without a charging station, home appliances, such as a wireless fan may need to be moved to charge a built-in battery, and then moved back to the use location after charging is complete, which may degrade user convenience.

### DISCLOSURE

### Technical Problem

Embodiments of the present disclosure aim to provide an electronic device capable of charging home appliances without separate charging stations or without moving the home appliances and an operating method thereof. An embodiment of the present disclosure provides an electronic device configured to automatically charge a home appliance by moving to a location of the home appliance using a charging service, connecting with a charging terminal of the home appliance through a discharging terminal, and supplying power stored in a battery.

### Technical Solution

To overcome the aforementioned technical problems, the present disclosure provides an electronic device configured to provide a charging service. An aspect of the present disclosure provides an electronic device configured to provide a charging service, the electronic device including: a driving module; a battery; a discharging interface configured to supply power to at least one charging service use device by discharging power stored in the battery; a communication interface configured to perform data transmission and reception with the at least one charging service use device by using a short-range communication network; a memory storing at least one instruction; and at least one processor configured to execute the at least one instruction to: control the communication interface to receive, from the at least one charging service use device, charging state information including at least one of device identification information, charging specifications, a current remaining battery capacity, and expected discharge time; generate a charging schedule for supplying charging power to the at least one charging service use device based on a remaining capacity of the battery and received charging state information of the at least one charging service use device; determine a charging target device from among the at least one charging service use device based on the charging schedule; control the driving module to move towards a location of the determined charging target device; and charge the charging target device by supplying power stored in the battery to the charging target device through connection with a charging terminal of the charging target device.

In an embodiment, the at least one processor may be further configured to execute the at least one instruction to: through the communication interface, receive a signal for requesting charging power supply from the at least one charging service request device and in response to the signal for requesting charging power supply being received, transmit a signal for requesting current battery charging state information and charging specifications information to the at least one charging service request device; and receive at least one of among device identification information, current battery charging state information, and charging specifications information from the at least one charging service request device.

In an embodiment, the electronic device may further include a data storage storing a charging service use device list including information related to at least one of device identification information, a battery capacity, and charging specifications information of the at least one charging service use device, wherein the at least one processor may be further configured to execute the at least one instruction to store information received from the at least one charging service request device in the charging service use device list.

In an embodiment, the at least one charging service request device may be a device logged in by using the same user account as the electronic device and preregistered at an Internet of Things (IoT) server.

In an embodiment, the at least one processor may be further configured to execute the at least one instruction to: receive use history information including at least one of a use start time, a use end time, a constant use state, and use time from the at least one charging service use device through the communication interface; and determine a charging order of the at least one charging service use device based on the expected discharge time estimated according to use history information of each of the at least one charging service use device.

In an embodiment, the electronic device may further include an infrared sensor configured to receive an infrared signal transmitted by the charging target device, wherein the at least one processor may be further configured to execute the at least one instruction to: identify a location of the charging target device based on an infrared signal received through the infrared sensor and determine a travel route to move towards the identified location; and control the driving module to move along the determined travel route.

In an embodiment, the at least one processor may be further configured to execute the at least one instruction to identify a direction and an angle of a charging terminal of the charging target device based on a signal intensity of an infrared signal received through the infrared sensor.

In an embodiment, the at least one processor may be further configured to execute the at least one instruction to: determine whether a first charging target device is charged to a preset target value; control the driving module to move towards a location of a second charging target device according to a charging order determined by the charging schedule; and control the discharging interface to charge the second charging target device by discharging the battery.

In an embodiment, the electronic device may further include a converter configured to convert charging power, wherein the at least one processor may be further configured to execute the at least one instruction to: control the converter to convert power supplied from the battery based on a rated voltage, a maximum allowable current, and a frequency included in charging specifications information received from the charging target device; and control the discharging interface to supply the converted power to the charging target device.

In an embodiment, the at least one processor may be further configured to execute the at least one instruction to: determine whether the charging target device is charged over a preset threshold value and control the discharging interface to discontinue charging power supply based on a result of the determination; and control the driving module to move towards a charging station to charge the battery.

To overcome the aforementioned technical problem, another aspect of the present disclosure provides a method operated by an electronic device, the method including: receiving, from at least one charging service use device, charging state information including at least one from among device identification information, charging specifications, a current remaining battery capacity, and an expected discharge time; generating a charging schedule to determine a time and a charging order for supplying charging power to the at least one charging service use device based on a remaining capacity of a built-in battery of the electronic device and the received charging state information; determining a charging target device from among the at least one charging service use device based on the charging schedule; moving towards a location of the determined charging target device; and charging the charging target device by supplying power stored in the battery to the charging target device through connection with a charging terminal of the charging target device.

In an embodiment, the method may further include, by the electronic device: receiving a signal for requesting charging power supply from at least one charging service request device by using a short-range communication network; in response to the signal for requesting charging power supply being received, transmitting a signal for requesting current battery charging state information and charging specifications information to the at least one charging service request device; and receiving at least one of device identification information, current battery charging state information, and charging specifications information from the at least one charging service request device.

In an embodiment, the method may further include, by the electronic device, storing information received from the at least one charging service request device in a charging service use device list.

In an embodiment, the at least one charging service request device may be a device logged in by using the same user account as the electronic device and preregistered at an Internet of Things (IoT) server.

In an embodiment, the receiving of the charging state information may include receiving use history information including at least one of a use start time, a use end time, a constant use state, and use time from the at least one charging service use device, and the generating of the charging schedule may include determining a charging order of the at least one charging service use device based on the expected discharge time estimated according to use history information of each of the at least one charging service use device.

In an embodiment, the moving towards a location of the charging target device may include: receiving an infrared signal transmitted by the determined charging target device; identifying a location of the charging target device based on the received infrared signal; determining a travel route to move towards the identified location; and controlling a driving module to move along the determined travel route.

In an embodiment, the moving towards a location of the charging target device may further include identifying a direction and an angle of a charging terminal of the charging target device based on a signal intensity of the received infrared signal.

In an embodiment, the charging of the charging target device may include, after charging a first charging target device to a preset target value, moving to a location of a second charging target device according to a charging order determined by the charging schedule and charging the second charging target device.

In an embodiment, the charging of the charging target device may include: converting power supplied from the battery based on a rated voltage, a maximum allowable current, and a frequency included in the charging specifications information received from the charging target device; and supplying the converted power to the charging target device.

To overcome the aforementioned technical problem, an embodiment according another aspect of the present disclosure provides a computer program product including a non-transitory computer-readable storage medium having recorded thereon a program to be executed on a computer.

### DESCRIPTION OF DRAWINGS

The present disclosure may be easily understood by referring to the following detailed description and the accompanying drawings, and the reference numerals denote structural elements.

FIG. 1A is a conceptual diagram illustrating a method of charging a charging service use device by an electronic device, according to an embodiment of the present disclosure.

FIG. 1B is a diagram illustrating components of an electronic device and a charging service use device, according to an embodiment of the present disclosure.

FIG. 2 is a block diagram illustrating components of an electronic device according to an embodiment of the present disclosure.

FIG. 3 is a flowchart illustrating a method of operating an electronic device, according to an embodiment of the present disclosure.

FIG. 4 is a block diagram illustrating components of a charging service use device according to an embodiment of the present disclosure.

FIG. 5 is a flowchart illustrating a method of storing, by an electronic device, a charging service request device in a charging service use device list.

FIG. 6 is a flowchart illustrating a method of charging, by an electronic device, a charging service use device, according to an embodiment of the present disclosure.

FIG. 7 is a flowchart illustrating a method of determining the charging schedule by an electronic device, according to an embodiment of the present disclosure.

FIG. 8A is a diagram illustrating an embodiment in which an electronic device of the present disclosure identifies a location of a charging target device.

FIG. 8B is a plan view of some components of a charging target device according to an embodiment of the present disclosure.

FIG. 9 is a flowchart illustrating how an electronic device moves towards a location of a charging target device, according to an embodiment of the present disclosure.

FIG. 10 is a diagram illustrating an embodiment in which an electronic device of the present disclosure returns to a charging station after charging target devices according to a charging schedule.

FIG. 11 is a diagram illustrating an embodiment in which an electronic device of the present disclosure determines a charging schedule according to electric charges per time periods.

FIG. 12A is a diagram illustrating an embodiment in which an electronic device is connected to a plurality of charging service use devices, a server, and a display device, according to an embodiment of the present disclosure.

FIG. 12B is a diagram illustrating an embodiment in which a display device of the present disclosure displays a charging subscription service user interface (UI) by executing an application.

FIG. 12C is a diagram illustrating an embodiment in which a display device of the present disclosure displays a charging UI by executing a charging subscription service application.

### MODE FOR INVENTION

General terms which are currently used widely have been selected for use in consideration of their functions in embodiments of the present disclosure; however, such terms may be changed according to an intention of a person skilled in the art, precedents, advent of new technologies, etc. Furthermore, in certain cases, terms have been arbitrarily selected by the applicant, and in such cases, meanings of the terms will be explained in detail in corresponding descriptions. Accordingly, the terms used in the embodiments of the present disclosure should be defined based on their meanings and overall descriptions of the embodiments of the present disclosure, not simply by their names.

An expression used in the singular encompasses the expression of the plural, unless it has a clearly different meaning in the context. The terms used herein, including technical or scientific terms, may have the same meaning as commonly understood by one of ordinary skill in the art.

Throughout the specification, when a portion “includes” a component, another component may be further included, rather than excluding the existence of other components, unless otherwise described. In addition, the terms “ . . . portion,” “module,” etc., described in the specification refer to a unit for processing at least one function or operation, which can be implemented by hardware or software, or a combination of hardware and software.

The expression of “configured to” used herein may be replaced with, for example, “suitable for,” “having the capacity to,” “designed to,” “adopted to,” “made to,” or “capable of” as applicable. Hardware-wise, the expression “configured to” may not necessarily mean “specifically designed to.” Instead, in some cases, the expression “a system configured to . . . ” may mean that “a system is capable of . . . together with other devices and parts. For example, the expression “a processor configured to perform A, B, and C” may mean a dedicated processor for performing A, B, and C (e.g., an embedded processor) or a generic-purpose processor (e.g., a central processing unit or an application processor) capable of performing A, B, and C by executing one or more software programs stored in a memory.

The expression “charging service” used herein refers to a function or operation of supplying charging power to a battery of a target device by discharging a built-in battery of an electronic device. The charging service may be provided by an electronic device, and the electronic device may move towards a location of a target device and supply charging power to charge a battery of the target device by connecting to a charging terminal of the target device.

The expression “electronic device” used herein refers to a device configured to provide a charging service to a target device. In an embodiment, the electronic device may include a built-in battery and provide charging power to a target device by discharging the battery through a discharging terminal.

The term “charging service use device” used herein refers to a device which receives a charging service from the electronic device. The charging service use device may charge a built-in battery by receiving power from the electronic device. The charging service use device may be, for example, a home appliance such as a wireless fan, a wireless cleaner, an air purifier, a wireless LED light, a Bluetooth speaker, a wirelessly rechargeable stand, etc.; however, the present disclosure is not limited thereto, and the charging service use device may be implemented as any electronic device including a battery.

Terminology such as “at least one of A and B”, as used herein, includes any of the following: A, B, A and B. As an additional example, terminology such as “at least one of A, B, and C”, as used herein, includes any of the following: A, B, C, A and B, A and C, B and C, A and B and C.

Hereinafter, embodiments of the present disclosure will be described in detail with reference to the accompanying drawings so that a person of ordinary skill in the art may easily perform the present disclosure. However, the disclosure may be implemented in various different forms and is not limited to the embodiments described herein.

Hereinafter, embodiments of the present disclosure will be described in detail with reference to the drawings.

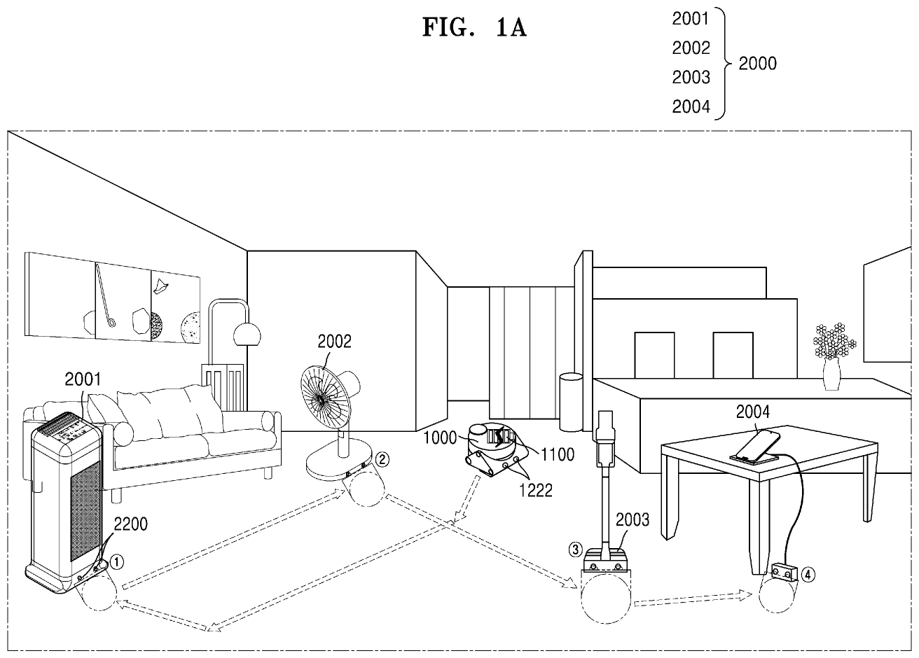

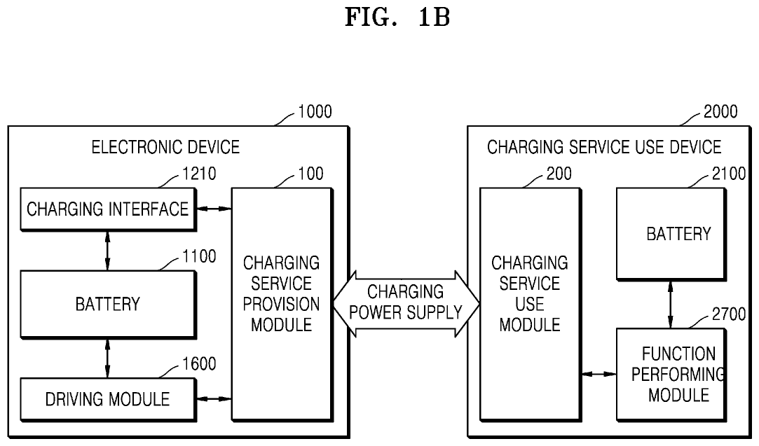

FIG. 1A is a conceptual diagram for illustrating a method of charging a charging service use device by an electronic device 1000, according to an embodiment of the present disclosure.

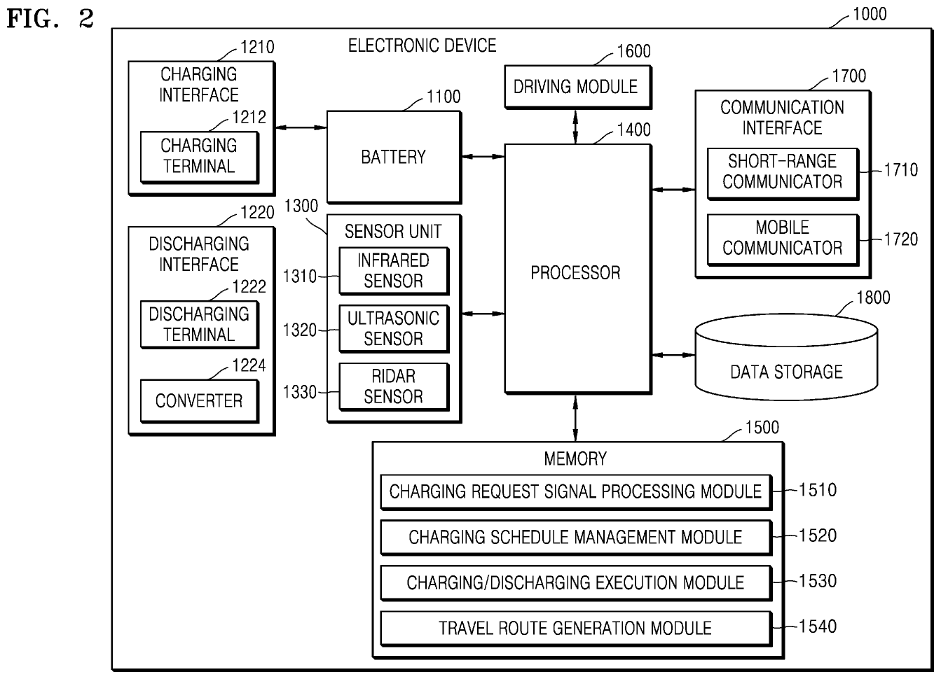

Referring to FIG. 1A, the electronic device 1000 may include a battery 1100 and may supply charging power to a charging service use device 2000 by discharging the battery 1100. In the embodiment illustrated in FIG. 1A, the electronic device 1000 may be a robot cleaner that includes the battery 1100 and moves towards a location of the charging service use device 2000. However, the present disclosure is not limited thereto, and the electronic device 1000 of the present disclosure may be implemented by any form of electronic devices including the battery 1100 and a driving module 1600 (see FIG. 2).

The charging service use device 2000 may include at least one home appliance. In the embodiment illustrated in FIG. 1A, the charging service use device 2000 may include a plurality of home appliances including a first charging service use device 2001 to a fourth charging service use device 2004. The charging service use device 2000 may include at least one home appliance from among an air purifier, a wireless fan, a wireless cleaner, a wireless LED light, a Bluetooth speaker, and a wirelessly rechargeable stand. However, the present disclosure is not limited thereto, and the charging service use device 2000 may be implemented by any electronic device that includes a battery.

The electronic device 1000 may receive, from the charging service use device 2000, charging state information including at least one from among device identification information, charging specifications, a current remaining battery capacity, and an expected discharge time. The electronic device 1000 may generate a charging schedule for determining a charging target device from the charging service use device 2000 based on charging state information. The electronic device 1000 may determine a charging target device from the charging service use device 2000 based on the charging schedule. The electronic device 1000 may move towards a location of the determined charging target device and charge the charging target device.

In the embodiment illustrated in FIG. 1A, the electronic device 1000 may determine the first charging service use device 2001 as a charging target device based on the charging schedule and move towards a location of the first charging service use device 2001. The electronic device 1000 may charge the first charging service use device 2001 by connecting with a charging terminal 2200 of the first charging service use device 2001 through a discharging terminal 1222 and supplying power stored in the battery 1100 to the first charging service use device 2001. When a built-in battery of the first charging service use device 2001 is charged to a preset target value, the electronic device 1000 may move towards a location of a second charging service use device 2002 according to the charging schedule and supply charging power to the second charging service use device 2002. In the embodiment illustrated in FIG. 1A, the electronic device 1000 may sequentially move and supply charging power to the first charging service use device 2001, the second charging service use device 2002, the third charging service use device 2003, and the fourth charging service use device 2004 according to the order of the charging schedule.

FIG. 1B is a diagram illustrating components of the electronic device 1000 and the charging service use device 2000, according to an embodiment of the present disclosure.

Referring to FIG. 1B, the electronic device 1000 may be a device configured to charge the charging service use device 2000 by supplying power stored in the battery 1100 to the charging service use device 2000 through a charging service provider module 100. The electronic device 1000 may include the charging service provider module 100, the battery 1100, a charging interface 1210, and a driving module 1600. The charging service provider module 100 may be configured to connect to the charging service use device 2000 and supply charging power to the charging service use device 2000. The charging service provider module 100 may be a hardware device including, in addition to the discharging terminal 1222 (see FIG. 2) connected to the charging terminal 2200 (see FIG. 1A) of the charging service use device 2000, a processor 1400 (see FIG. 2), a memory 1500 (see FIG. 2), and a communication interface 1700 (FIG. 2). Components of the electronic device 1000 are described in detail with reference to FIG. 2.

The charging service use device 2000 may be a device configured to receive charging power from the electronic device 1000 and charge a built-in battery 2100. The charging service use device 2000 may include a charging service use module 200, the battery 2100, and a function performing module 2700.

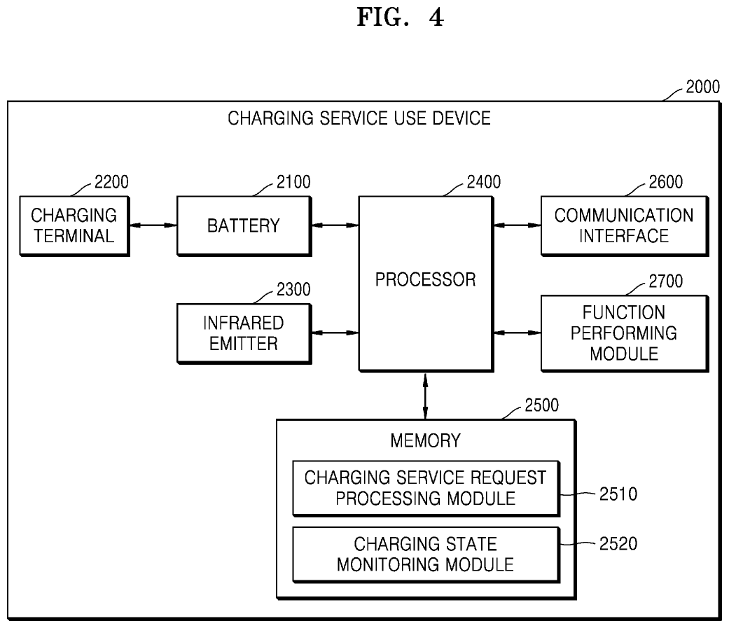

The charging service use device 2000 may connect to the discharging terminal 1222 of the electronic device 1000 through the charging terminal 2200 included in the charging service use module 200 and receive charging power for charging the battery 2100 through the charging terminal 2200. The charging service use module 200 may be a hardware device including a processor 2400 (see FIG. 4), a memory 2500 (see FIG. 4), and a communication interface 2600 (see FIG. 4) in addition to the charging terminal 2200.

The function performing module 2700 may be a hardware device configured to perform a characteristic function and/or operation of the charging service use device 2000. The charging service use device 2000 may include, for example, at least one of an air purifier, a wireless fan, a wireless cleaner, a wireless LED light, a Bluetooth speaker, and a wirelessly rechargeable stand, and the function performing module 2700 may perform a characteristic function/operation according to a type of a home appliance. For example, when the charging service use device 2000 is a wireless fan, the function performing module 2700 may include blades of and a rotation motor of a fan.

Components of the charging service use device 2000 are described in detail with reference to FIG. 4.

In prior arts, to charge a built-in battery of a home appliance, a charging station that provides a charging function through docking is used, or a method of receiving charging power through a wall power outlet by using a charging device (e.g., a charging adaptor) is employed. As for the charging method using a charging station, although mobility during user is secured with the utilization of battery, as the charging station still needs to use a power source buried in a wall, there are limits to determining an installation place. In addition, when using a charging station, a wall power outlet is required, and thus, home appliances need to be moved for charging after using them. This may cause inconvenience, and the complex wiring may ruin the aesthetic view of interior space. When charging home appliances by using a charging adaptor instead of charging station, the home appliances need to be moved to charge built-in batteries of the home appliances, and need to be moved back to the use locations after charging is complete, which may cause degradation of user convenience.

In an embodiment illustrated in FIGS. 1A and 1B, the electronic device 1000 may move towards a location of the at least one charging service use device 2000 and supply power stored in the battery 1100 as charging power by connecting to the charging terminal 2200 of the at least one charging service use device 2000 through the discharging terminal 1222. According to an embodiment of the present disclosure, as the electronic device 1000 moves around for charging of the at least one charging service use device 2000, the limitation in selecting a location of the at least one charging service use device 2000 may be removed. As a result, not only user convenience may be enhanced but also the aesthetic interior view may be improved by flexible arrangement of the devices. As the electronic device 1000 according to an embodiment of the present disclosure automatically moves towards a location of the at least one charging service use device 2000 and supply charging power, electric wires for extension to connect to a wall power outlet, a power strip, a separate charging adaptor, etc. may not be required, which leads to improved user convenience.

Moreover, as the electronic device 1000 according to an embodiment of the present disclosure automatically provides a charging service according to a battery charging state of the at least one charging service use device 2000, the cumbersome work of constantly checking on the battery state of home appliances and charging them by a user him or herself may be eliminated.

FIG. 2 is a block diagram illustrating components of the electronic device 1000 according to an embodiment of the present disclosure.

The electronic device 1000 may be a device configured to charge at least one charging service use device 2000 (see FIGS. 1A and 1B) by using the built-in battery 1100. The electronic device 1000 may be, for example, a robot cleaner; however, the present disclosure is not limited thereto.

Referring to FIG. 2, the electronic device 1000 may include the battery 1100, the charging interface 1210, a discharging interface 1220, a sensor portion 1300, the processor 1400, the memory 1500, the driving module 1600, the communication interface 1700, and a data storage 1800. The battery 1100, the charging interface 1210, the discharging interface 1220, the sensor portion 1300, the processor 1400, the memory 1500, the driving module 1600, the communication interface 1700, and the data storage 1800 may each electrically and/or physically connected to each other.

The components illustrated in FIG. 2 are merely according to an embodiment of the present disclosure and the components included in the electronic device 1000 are not limited to the description of FIG. 2. The electronic device 1000 may not include some of the components illustrated in FIG. 2 or may further include components that are not illustrated in FIG. 2. For example, the electronic device 1000 may include a display displaying a graphic user interface (UI) showing a current remaining capacity of the battery 1100, a charging time and a charging order according to a charging schedule, a charging complete time, or an expected discharge time of the battery 1100. In an embodiment, the display may include a touch screen receiving a touch input of a user.

The battery 1100 may not only operate the electronic device 1000 by supplying drive power to components of the electronic device 1000 but also store power supplied to charge a built-in battery of at least one charging service use device 2000 (see FIGS. 1A and 1B). The battery 1100 may include a rechargeable secondary cell. The battery 1100 may include, for example, a Li-Ion battery, a Li-Ion polymer battery (LIPB), a Ni—Cd battery, a Ni-MH battery, etc.; however, the present disclosure is not limited thereto. The battery 1100 may be charged by using power supplied through the charging interface 1210.

The charging interface 1210 may be configured to charge the battery 1100 by providing to the battery 1100 power supplied through a wall power outlet or a charging adapter. The charging interface 1210 may include a charging terminal 1212. The charging terminal 1212 may include a plurality of terminals including conductors. The charging terminal 1212 may include, for example, a conductor having lower electric resistance, such as copper (Cu). However, the present disclosure is not limited thereto. The charging terminal 1212 may be formed to be exposed outside a housing of the electronic device 1000. The charging terminal 1212 may be formed, for example, to be exposed outwards on a front cover of the housing of the electronic device 1000 or arranged on a rear side of the electronic device 1000 to face the bottom surface.

The discharging interface 1220 may be configured to supply power to at least one charging service use device 2000 (see FIGS. 1A and 1B) by discharging power prestored in the battery 1100. The discharging interface 1220 may include the discharging terminal 1222 and a converter 1224.

The discharging terminal 1222 may be formed to be exposed outside the housing of the electronic device 1000, and may supply power stored in the battery 1100 by electrically and/or physically connecting to the charging terminal 2200 (see FIG. 1A) of the at least one charging service use device 2000. In an embodiment, the discharging terminal 1222 may be integrated with the charging terminal 1212 and perform both charging and discharging.

The converter 1224 may be configured to convert an output current, an output voltage, and a frequency based on charging specifications of at least one charging service use device 2000. The converter 1224 may convert at least one of a voltage, a current, and a frequency, which are output from the battery 1100 based on charging specifications information including a rated voltage, a maximum allowable current, and a frequency, which are received from the at least one charging service use device 2000.

The sensor unit 1300 may include a plurality of sensors configured to sense information about an environment around the electronic device 1000. The sensor unit 1300 may include an infrared sensor 1310, an ultrasonic sensor 1320, and a light detection and ranging (LiDAR) sensor 1330.

The infrared sensor 1310 may sense infrared light transmitted from the at least one charging service use device 2000. The infrared sensor 1310 may sense an intensity, a transmission angle, and a transmission location of an infrared signal. The infrared sensor 1310 may provide information about the intensity, the transmission angle, and the transmission location of the infrared signal to the processor 1400. The processor 1400 may identify a location of the at least one charging service use device 2000 based on the information obtained from the infrared sensor 1310. In an embodiment, the infrared sensor 1310 may obtain device identification information (e.g., device ID) of the at least one charging service use device 2000, which is included in the infrared signal.

The ultrasonic sensor 1320 may transmit an ultrasonic signal to an object arranged around the electronic device 1000 and receive an ultrasonic echo signal reflected from the object to sense a distance between the object and the electronic device 1000. The ultrasonic sensor 1320 may include at least one transducer configured to convert the ultrasonic echo signal into an electric signal. The ultrasonic sensor 1320 may provide information about a distance to a sensed object to the processor 1400. The processor 1400 may sense an object on a travel route to the at least one charging service use device 2000 by analyzing the ultrasonic echo signal.

The LiDAR sensor 1330 may sense at least one of a distance, a direction, a speed, a temperature, a material distribution, and a concentration property by emitting a pulsed laser beam to an object and measuring time taken and intensity of the pulsed laser beam reflected from the object. The LiDAR sensor 1330 may create a three-dimensional (3D) map of spatial structure including walls, objects, etc. of an interior space by using the sensed information.

Although it is not shown in the drawings, the sensor unit 1300 may further include at least one of a fall prevention sensor, an image sensor (e.g., a stereo camera, a mono camera, a wide angle camera, an around view camera, a 3D vision sensor, etc.), an obstacle sensor (3D sensor), and a travel distance sensing sensor.

The processor 1400 may execute at least one instruction or program code stored in the memory 1500 and perform functions and/or operations corresponding to the instructions or program codes. The processor 1400 may include hardware components performing arithmetic, logic, and input/output operations and signal processing. The processor 1400 may include at least one of a central processing unit, a microprocessor, a graphic processing unit, an application processor (AP), application specific integrated circuits (ASICs), digital signal processors (DSPs), digital signal processing devices (DSPDs), programmable logic devices (PLDs), and field programmable gate arrays (FPGAs); however, the present disclosure is not limited thereto.

FIG. 2 illustrates the processor 1400 as one element; however, the present disclosure is not limited thereto. In an embodiment, the processor 1400 may include one or more elements.

In an embodiment, the processor 1400 may include a hardware chip for performing artificial intelligence (AI) learning.

Instructions and program codes which are readable by the processor 1400 may be stored in the memory 1500. The memory 1500 may include, for example, at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk.

The memory 1500 may store data about a charging request signal processing module 1510, a charging schedule management module 1520, and a charging/discharging execution module 1530, and a travel route generation module 1540. A plurality of “modules” included in the memory 1500 may refer to a unit of processing a function or operation performed by the processor 1400 and may be implemented by software such as instructions or program codes.

In the following embodiment, the processor 1400 may be implemented by executing instructions or program codes stored in the memory 1500.

The charging request signal processing module 1510 may be a module configured to receive a signal for requesting charging power supply from a charging service request device and request current battery charging state information and charging specifications information from the charging service request device to obtain relevant information. The processor 1400 may receive a signal for requesting charging power supply from the charging service request device by using the communication interface 1700 and execute instructions or program codes related to the charging request signal processing module 1510 to transmit a signal for requesting current battery charging state information and charging specifications information to the charging service request device. The processor 1400 may receive at least one of device identification information (e.g., device ID), current battery charging state information, and charging specifications information from the charging service request device through the communication interface 1700. Here, the “charging specifications information” may include at least one of a rated voltage, a maximum allowable current, and a frequency of the charging service request device. The processor 1400 may store the device identification information, the current battery charging state information, and the charging specifications information, which are received from the charging service request device, in at least one charging service use device list. The charging service use device list may be stored in the data storage 1800.

The charging schedule management module 1520 may be a module configured to generate a charging schedule determining charging time and charging order of the at least one charging service use device 2000 based on the remaining capacity of the battery 1100 and the charging state information received from the charging service use device 2000. The processor 1400 may determine charging time and charging order of each of the at least one charging service use device 2000 included in the charging service use device list stored in the data storage 1800 by executing instructions or program codes related to the charging schedule management module 1520. In an embodiment, the processor 1400 may generate a charging schedule of the at least one charging service use device 2000 based on at least one of device identification information, device type, a current remaining battery capacity, and an expected discharge time, which are received from the at least one charging service use device 2000.

In an embodiment, the processor 1400 may receive use history information including at least one of a use start time, a use end time, a constant use state, and use time from the charging service use device 2000 through the communication interface 1700 and determine a charging order of the at least one charging service use device 2000 based on an expected discharge time estimated according to use history information of each of the at least one charging service use device 2000. For example, the processor 1400 may manage the charging schedule to charge a charging service use device which has been used for long time and is close to its expected battery discharge time is charged before other devices.

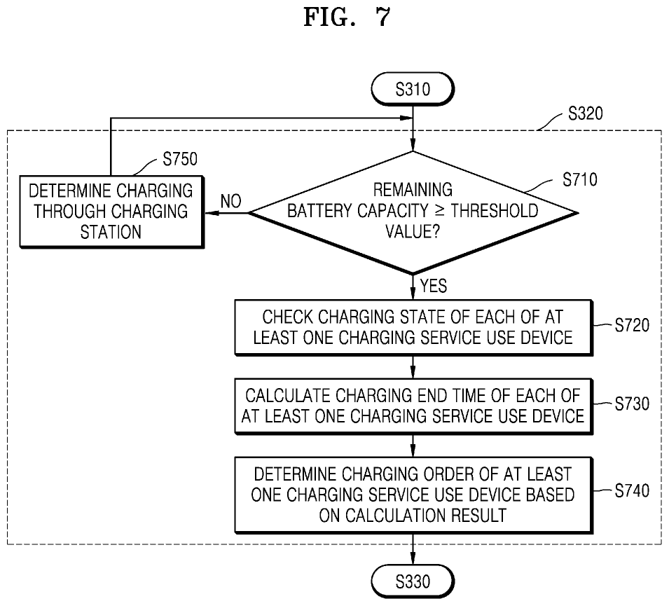

In an embodiment, the processor 1400 may determine a charging schedule based on characteristics and urgency of the at least one charging service use device 2000. The processor 1400 may determine the charging schedule to charge a device which is never turned off by a user and is constantly used or has high urgency in relation to storage of food, etc., for example, a refrigerator before other charging service use devices. Specific embodiments in which the processor 1400 generates a charging schedule are described in detail with reference to FIG. 7.

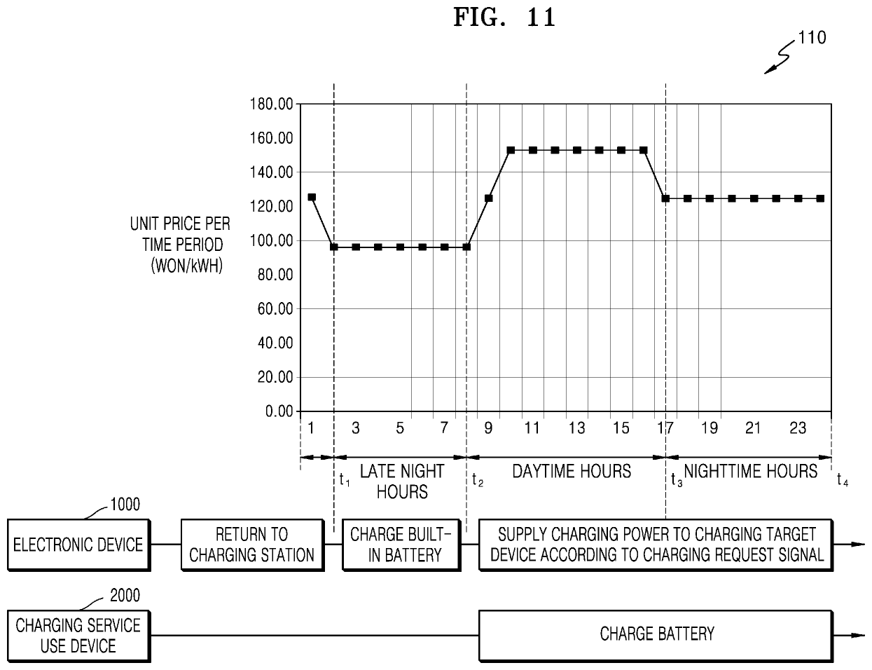

In an embodiment, the processor 1400 may determine a discharging and charging schedule of the battery 1100 based on electric charges per time period. For example, when a normal electric rate is charged from 9 am to 11 pm, and a relatively lower electric rate is charged during late night hours, e.g., from 1 am to 7 am, the processor 1400 may determine a charging schedule to supply charging power to at least one charging service use device by discharging the battery 1100 during the time periods when the normal electric rate is applied. In addition, the processor 1400 may determine a charging schedule to charge the battery 1100 by moving to a charging station during the late night hours. Specific embodiments in which the processor 1400 determines a charging schedule according to electric charges per time period are described in detail with reference to FIG. 11.

The processor 1400 may store the generated charging schedule in the data storage 1800.

The charging/discharging execution module 1530 may be a module configured to determine a charging target device among the at least one charging service use device 2000 according to the charging schedule. The processor 1400 may determine a charging target device according to the charging schedule by executing instructions or program codes which are related to the charging/discharging execution module 1530. In an embodiment, the processor 1400 may identify a location of the charging target device by transmitting a signal for requesting transmission of a location signal to the charging target device and receiving an infrared signal transmitted from the charging target device. The processor 1400 may supply charging power to the charging target device by controlling the driving module 1600 to move the electronic device 1000 to the identified location and discharging the battery 1100 through the discharging interface 1220.

In an embodiment, the processor 1400 may convert the charging power according to charging specifications information of the charging target device by using the converter 1224. Through the control by the processor 1400, the converter 1224 may convert power supplied from the battery 1100 to correspond to a rated voltage, a maximum allowable current, and a frequency of the charging target device. The processor 1400 may supply the converted power to the charging target device through the discharging interface 1220.

The processor 1400 may supply charging power to the charging target devices sequentially according to the charging order included in the charging schedule. In an embodiment, the processor 1400 may identify whether a first charging target device is charged to a preset target value and when the first charging target device is charged over the target value, the processor 1400 may supply charging power to a second charging target device determined according to the charging schedule.

The travel route generation module 1540 may be a module configured to identify a location of a charging target device through an infrared signal transmitted from the charging target device and generate a travel route to the location of the charging target device. The processor 1400 may receive a directional infrared signal transmitted from the charging target device through the infrared sensor 1310 and identify the location of the charging target device by using the received directional infrared signal. The processor 1400 may generate a travel route to move towards the location of the charging target device by executing instructions or program codes which are related to the travel route generation module 1540. In an embodiment, the processor 1400 may generate a travel route to move towards the location of the charging target device by using information about objects around the electronic device 1000 obtained from the ultrasonic sensor 1320 and a 3D map of an interior space obtained from the LiDAR sensor 1330. In an embodiment, the processor 1400 may generate a 3D map by scanning the entire space in which the electronic device 1000 is deployed by using the simultaneous localization and mapping (SLAM) technology and by using the 3D map, generate a travel route to move towards the location of the charging target device.

The driving module 1600 may be a device configured to move the electronic device 1000 towards the location of the charging service use device 2000. The driving module 1600 may include a pair of wheels which rotate and move the electronic device 1000 back and forth, a wheel motor applying locomotive power to each wheel, a caster wheel which is provided on the front of a main body and spins at different angles according to a state of a ground surface on which the electronic device 1000 moves. The wheel motor may drive and spin each wheel independently in forward reverse direction and may be able to spin each wheel at different spin rates. In an embodiment, the processor 1400 may control the driving module 1600 to move the electronic device 1000 along the travel route.

The communication interface 1700 may be configured to perform data communication with at least one charging service use device 2000 or an external server. The communication interface 1700 may include a short-range wireless communicator 1710 and a mobile communicator 1720.

The short-range wireless communicator 1710 may include at least one hardware from among a Wi-Fi Direct (WFD) communication device, a Bluetooth communication device, a Bluetooth low energy (BLE) communication device, a near field communication unit, a wireless local area network (Wi-Fi) communication device, a Zigbee communication device, an ultra wideband (UWB) communication device, an Ant+ communication device, and a micro wave (uWave) communication device; however, the present disclosure is not limited thereto. In an embodiment, the short-range wireless communicator 1710 may include an application layer implementing a charging service protocol such as smart energy protocol (SEP) 2.0 or open connectivity foundation protocol (OCF) in a Wi-Fi communication device, a Bluetooth communication device, or a Zigbee communication device.

The mobile communicator 1720 may be configured to transmit and receive a wireless signal to and from at least one of a station, an external device, and a server on a mobile communication network.

The data storage 1800 may be a storage medium storing at least one of the charging service use device list, the charging schedule, and the travel route. The data storage 1800 may include a non-volatile memory. A non-volatile memory refers to a storage medium which stores and maintains information even when power is not supplied and uses stored information when power is supplied. The non-volatile memory may include, for example, at least one of a flash memory, a hard disk, a solid state drive (SSD), a multimedia card micro type memory, a card type memory (e.g., SD or XD memory, etc.), a read only memory (ROM), a magnetic memory, a magnetic disk, an optical disk.

FIG. 2 illustrates the data storage 1800 as being included in the electronic device 1000; however, the present disclosure is not limited thereto. In an embodiment, the data storage 1800 may be implemented in the form of an external memory which is not included in the electronic device 1000 or may be implemented as a web-based storage medium which provides wired or wireless communication through the communication interface 1700.

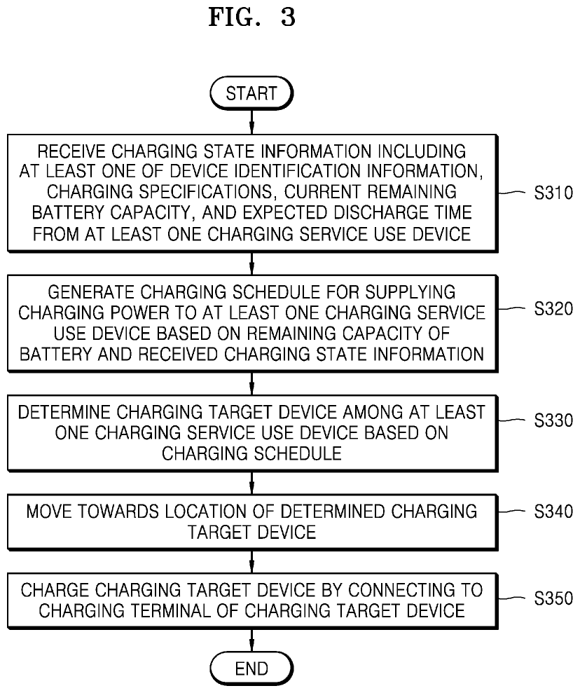

FIG. 3 is a flowchart illustrating a method of operating the electronic device 1000 according to an embodiment of the present disclosure.

In operation S310, the electronic device 1000 may receive, from at least one charging service use device, charging state information including at least one from among device identification information, charging specifications, a current remaining battery capacity, and an expected discharge time. Here, the “charging specifications information” may include information about at least one of a rated voltage, a maximum allowable current, and a frequency of the charging service request device. In an embodiment, the electronic device 1000 may receive use history information from the at least one charging service use device. The use history information may include at least one of a use start time, a use end time, a constant use state, and use time of each of the at least one charging service use device. In an embodiment, the electronic device 1000 may predict an expected discharge time of a built-in battery of each of the at least one charging service use device based on the received use history information.

In an embodiment, the electronic device 1000 may store the charging state information received from the at least one charging service request device in the data storage 1800 (see FIG. 2).

In operation S320, the electronic device 1000 may generate a charging schedule to supply charging power to at least one charging service use device based on a remaining capacity of a battery and received charging state information. In an embodiment, the electronic device 1000 may generate a charging schedule determining charging time and charging order of at least one charging service use device based on a remaining capacity of a built-in battery and information received from each of the at least one charging service use device regarding charging specifications, a current remaining battery capacity, and an expected discharge time.

In an embodiment, the electronic device 1000 may determine a charging order of the at least one charging service use device based on the expected discharge time estimated according to use history information of the at least one charging service use device. For example, the electronic device 1000 may determine the charging order to charge a charging service use device which is used constantly or has been used relatively longer than other devices and is close to its expected battery discharge time, before other devices.

In an embodiment, the electronic device 1000 may determine a charging schedule based on characteristics and urgency of at least one charging service use device. The electronic device 1000 may determine the charging schedule to charge a device which is never turned off by a user and is constantly used or has high urgency in relation to storage of food, etc., for example, a refrigerator before other charging service use devices.

In an embodiment, the electronic device 1000 may determine discharging and charging time based on electric charges per time period. The electronic device 1000 may determine a charging schedule to supply charging power to at least one charging service use device by discharging the built-in battery during the time periods when a normal electric rate is charged, for example, from 9 am to 11 pm, and moving to a charging station to charge the built-in battery during late night hours when a lower electric rate is applied, e.g., from 1 am to 7 am.

In operation S330, the electronic device 1000 may determine a charging target device from among the at least one charging service use device based on the charging schedule. In an embodiment, the electronic device 1000 may determine a charging target device from among the at least one charging service use device according to the charging time and charging order determined by the charging schedule.

In operation S340, the electronic device 1000 may move towards a location of the determined charging target device. In an embodiment, the electronic device 1000 may receive an infrared signal transmitted from the charging target device by using the infrared sensor 1310 (see FIG. 2) and identify the location of the charging target device by using the received infrared signal. In an embodiment, the electronic device 1000 may generate a travel route to move towards the location of the charging target device by using information about objects around the electronic device 1000 obtained from the ultrasonic sensor 1320 (see FIG. 2) and a 3D map of an interior space obtained from the LiDAR sensor 1330 (see FIG. 2). The electronic device 1000 may move towards the location of the charging target device along the travel route.

In operation S350, the electronic device 1000 may charge the charging target device by connecting to the charging terminal of the charging target device. In an embodiment, the electronic device 1000 may identify a direction and an angle of the charging terminal of the charging target device by using information about signal intensity of an infrared signal. The electronic device 1000 may determine a location and a direction of the discharging terminal 1222 by using information about the identified direction and angle of the charging terminal of the charging target device and supply charging power to the charging target device by connecting the discharging terminal 1222 to the charging terminal of the charging target device.

FIG. 4 is a block diagram illustrating components of the charging service use device 2000 according to an embodiment of the present disclosure.

The charging service use device 2000 may be a device configured to receive charging power from the electronic device 1000 and charge a built-in battery 2100. The charging service use device 2000 may include at least one home appliance from among an air purifier, a wireless fan, a wireless cleaner, a wireless LED light, a Bluetooth speaker, and a wirelessly rechargeable stand. However, the present disclosure is not limited thereto, and the charging service use device 2000 may be implemented by any electronic device that includes the battery 2100.

Referring to FIG. 4, the charging service use device 2000 may include the battery 2100, the charging terminal 2200, an infrared emitter 2300, the processor 2400, the memory 2500, the communication interface 2600, and the function performing module 2700.

The battery 2100 may supply drive power to the components of the charging service use device 2000. The battery 2100 may include a rechargeable secondary cell. The battery 2100 may include, for example, a Li-Ion battery, a Li-Ion polymer battery (LIPB), a Ni—Cd battery, a Ni-MH battery, etc.; however, the present disclosure is not limited thereto. The battery 2100 may be charged by using power supplied through the charging terminal 2200.

The charging terminal 2200 may be connected to the discharging terminal 1222 (see FIG. 2) of the electronic device 1000 and receive power from the electronic device 1000 to charge the battery 2100. The charging terminal 2200 may include a plurality of terminals including conductors. The charging terminal 2200 may be formed to be exposed outside a housing of the charging service use device 2000. In an embodiment, the charging terminal 2200 may be arranged at a location and height corresponding to a location and height of the discharging terminal 1222 to be electrically and/or physically connected to the discharging terminal 1222 of the electronic device 1000.

The infrared emitter 2300 may be configured to send out an infrared signal according to the control by the processor 2400. The infrared emitter 2300 may include, for example, an infrared light-emitting element including an infrared light-emitting diode (IR LED). In an embodiment, the infrared emitter 2300 may include a plurality of infrared light-emitting elements. Each of the plurality of infrared light-emitting elements may transmit directional infrared signals having different frequencies or transmission angles from each other. The plurality of infrared light-emitting elements may transmit location information of the charging service use device 2000 to the electronic device 1000 by sending out a directional infrared signal having a particular frequency and angle. In an embodiment, the plurality of infrared light-emitting elements may respectively send out infrared signals having different codes from each other.

The infrared emitter 2300 may selectively transmit an infrared signal only during a time period determined by the processor 2400. When a signal informing that the charging service use device 2000 is selected as a charging target is received from the electronic device 1000, the processor 2400 may activate the infrared emitter 2300 to transmit an infrared signal.

The processor 2400 may execute at least one instruction or program code stored in the memory 2500 and perform functions and/or operations corresponding to the instructions or program codes. The processor 2400 may include hardware components performing arithmetic, logic, and input/output operations and signal processing. The processor 2400 may include at least one of a central processing unit, a microprocessor, an AP, ASICs, DSPs, DSPDs, PLDs, and FPGAs; however, the present disclosure is not limited thereto.

Instructions and program codes which are readable by the processor 2400 may be stored in the memory 2500. The memory 250 may include a charging service request processing module 2510 and a charging state monitoring module 2520. A plurality of “modules” included in the memory 2500 may refer to a unit of processing a function or operation performed by the processor 2400 and may be implemented by software such as instructions or program codes.

In the following embodiment, the processor 2400 may be may be implemented by executing instructions or program codes stored in the memory 2500.

The charging service request processing module 2510 may be a module configured to transmit device identification information and charging state information of the charging service use device 2000 to the electronic device 1000 in response to a charging state information request signal received from the electronic device 1000. The processor 2400 may receive a charging state information request signal from the electronic device 1000 through the communication interface 2600. When the charging state information request signal is received, the processor 2400 may control the communication interface 2600 to transmit to the electronic device 1000 charging state information including at least one of device identification information, a current remaining battery capacity, charging specifications, and an expected discharge time of the charging service use device 2000 by executing instructions or programs codes related to the charging service request processing module 2510. The processor 2500 may control the charging service request processing module 2510 to transmit a signal for requesting charging power supply to the electronic device 1000 by executing instructions or program codes of the communication interface 2600.

The charging state monitoring module 2520 may be configured to monitor a charging state of the battery 2100. In an embodiment, the processor 2400 may monitor a current remaining capacity and an expected discharge time of the battery 2100 by executing instructions or program codes related to the charging state monitoring module 2520. In an embodiment, the processor 2400 may monitor the charging state of the battery 2100 in real time; however, the present disclosure is not limited thereto. In another embodiment, the processor 2400 may monitor the charging state of the battery 2100 at a preset interval.

The communication interface 2600 may be configured to receive and transmit data from and to the electronic device 1000 according to the control by the processor 2400. In an embodiment, the communication interface 2600 may receive an query signal from the electronic device 1000. In an embodiment, the communication interface 2600 may transmit a charging power supply request signal and charging state information to the electronic device 1000.

The communication interface 2600 may include a WFD communication device, a Bluetooth communication device, a BLE communication device, a near field communication unit, a Wi-Fi communication device, a Zigbee communication device, an UWB communication device, an Ant+ communication device, an uWave communication device, etc.; however, the present disclosure is not limited thereto.

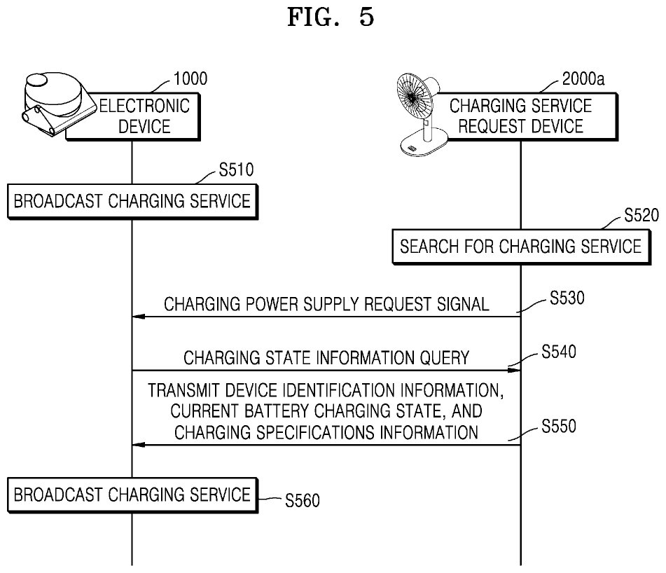

FIG. 5 is a flowchart illustrating a method of storing, by the electronic device 1000, a charging service request device 2000a in a charging service use device list.

The charging service request device 2000a may refer to a device which is not a charging service use device receiving charging power from the electronic device 1000 but is a candidate device which may become a charging service use device by providing signal for requesting charging power supply to the electronic device 1000.

In operation S510, the electronic device 1000 may broadcast a charging service. In an embodiment, the electronic device 1000 may transmit a signal advertising the charging service to host devices connected by using at least one short-range communication network from among Wi-Fi, Bluetooth, and Zigbee.

In operation S520, the charging service request device 2000a may search for a charging service. The charging service request device 2000a may be connected to the electronic device 1000 through a short-range communication network including at least one of Wi-Fi, Bluetooth, and Zigbee. The charging service request device 2000a may search for a charging service by receiving a signal broadcast by the electronic device 1000 through the short-range communication network. In an embodiment, the charging service request device 2000a may be a device logged in by using the same user account as the electronic device 1000 and registered at an IoT server.

In operation S530, the charging service request device 2000a may transmit a charging power supply request signal to the electronic device 1000. In an embodiment, the charging service request device 2000a may transmit a signal for requesting charging power supply to the electronic device 1000 by using a short-range communication network.

In operation S540, the electronic device 1000 may transmit a charging state information query signal to the charging service request device 2000a. The charging state information query signal may be a query signal for requesting transmission of at least one of device identification information, current battery charging state, and charging specifications information of the charging service request device 2000a.

In operation S550, the charging service request device 2000a may transmit device identification information, current battery charging state, and charging specifications information to the electronic device 1000. In an embodiment, the charging service request device 2000a may transmit an infrared signal including location information to the electronic device 1000.

In operation S560, the electronic device 1000 may store information related to the charging service request device 2000a in the charging service use device list. In an embodiment, the electronic device 1000 may store device identification information, current battery charging state, and charging specifications information of the charging service request device 2000a in the charging service use device list. In an embodiment, the electronic device 1000 may identify a location of the charging service request device 2000a based on a directional infrared signal received from the charging service request device 2000a and store information about the identified location in the charging service use device list.

Once stored in the charging service use device list, the charging service request device 2000a may become a charging service use device.

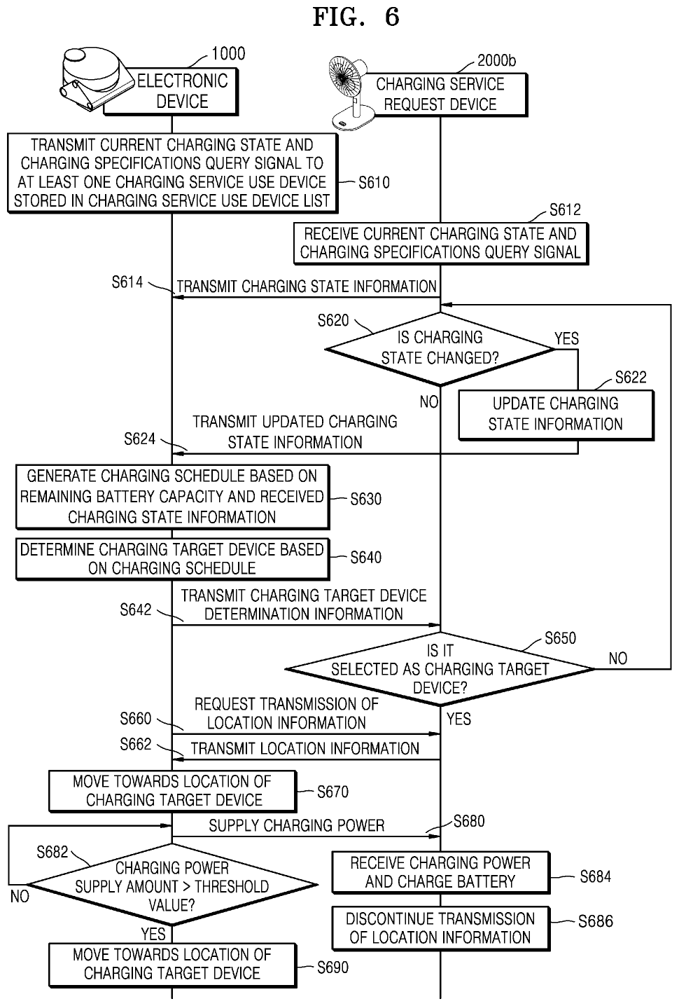

FIG. 6 is a flowchart illustrating a method of charging, by the electronic device 1000, a charging service use device 2000b according to an embodiment of the present disclosure.

In operation S610, the electronic device 1000 may transmit a current charging state and charging specifications query signal in relation to the at least one charging service use device stored in the charging service use device list. In an embodiment, the electronic device 1000 may transmit a query signal requesting current battery charging state and charging specifications of the at least one charging service use device through a short-range communication network including at least one of Wi-Fi, Bluetooth, and Zigbee.

In operation S612, the charging service use device 2000b may receive a current charging state and charging specifications query signal.

In operation S614, the charging service use device 2000b may transmit charging state information. In an embodiment, the charging service use device 2000b may transmit to the electronic device 1000 charging state information including at least one of device identification information, a current remaining battery capacity, charging specifications, and an expected discharge time through a short-range communication network.

In operation S620, the charging service use device 2000b may sense a change in the charging state. A change in the charging state may include, for example, the current remaining battery capacity dropped under a preset threshold value or an approach to the expected discharge time. In an embodiment, the charging service use device 2000b may monitor the remaining capacity of the battery 2100 and the expected discharge time of the battery 2100 in real time or at a preset interval by executing instructions or program codes related to the charging state monitoring module 2520 (see FIG. 4).

When a change in the charging state is sensed (operation S622), the charging service use device 2000b may update the charging state information.

In operation S624, the charging service use device 2000b may transmit the updated charging state information to the electronic device 1000.

In operation S630, the electronic device 1000 may generate a charging schedule based on the remaining capacity of the battery and the received charging state information. In an embodiment, the electronic device 1000 may generate a charging schedule determining charging time and charging order of at least one charging service use device based on a remaining capacity of a built-in battery and information received from each of the at least one charging service use device regarding charging specifications, a current remaining battery capacity, and an expected discharge time. Specific embodiments in which the electronic device 1000 determines the charging time and the charging order of the at least one charging service use device are the same as operation S320 of FIG. 3, and any redundant description will be omitted.

In operation S640, the electronic device 1000 may determine a charging target device based on the charging schedule. In an embodiment, the electronic device 1000 may determine a charging target device from among the at least one charging service use device according to the charging time and charging order determined by the charging schedule. In an embodiment illustrated in FIG. 6, the electronic device 1000 may determine the charging service use device 2000b as the charging target device.

In operation S642, the electronic device 1000 may transmit charging target device determination information to the charging service use device 2000b.

In operation S650, the charging service use device 2000b may determine whether the charging service use device 2000b is selected as a charging target device. In an embodiment, the charging service use device 2000b may receive the charging target device determination information through the short-range communication network and determine whether the charging service use device 2000b is selected as a charging target device based on the received charging target device determination information.

When the charging service use device 2000b is not selected as a charging target device, the charging service use device 2000b may return to the operation of sensing a change in charging state (operation S620) and perform sensing of changes in charging state.

In operation S660, the electronic device 1000 may transmit a query signal requesting transmission of location information of the charging service use device 2000b.

In operation S662, the charging service use device 2000b may send out a directional infrared signal including the location information to the electronic device 1000. The charging service use device 2000b may not always transmit the directional infrared signal and selectively activate the infrared emitter 2300 (see FIG. 4) only when a location information transmission request signal is received from the electronic device 1000. The charging service use device 2000b may send out a directional infrared signal by using the infrared emitter 2300.

In operation S670, the electronic device 1000 may move towards the location of the charging target device. In an embodiment, the electronic device 1000 may receive a directional infrared signal, identify a location of the charging service use device 2000b determined as a charging target device by using the received directional infrared signal, and determine a travel route to the identified location of the charging service use device 2000b. The electronic device 1000 may move towards the location of the charging service use device 2000b along the determined travel route.

In operation S680, the electronic device 1000 may supply charging power to the charging service use device 2000b. The electronic device 1000 may provide the charging service use device 2000b with the power stored in the battery as the charging power by discharging the built-in battery. In an embodiment, the electronic device 1000 may supply charging power for charging the battery included in the charging service use device 2000b by connecting the discharging terminal 1222 (see FIG. 1A) to the charging terminal 2200 (see FIG. 1A) of the charging service use device 2000b.

In operation S682, the electronic device 1000 may identify whether an amount of charging power supply exceeds a preset threshold value. The “preset threshold value” refers to an amount of charging power sufficient to charge the battery capacity of the charging service use device 2000b up to a target value. For example, the preset threshold value may refer to an amount of charging power amount that can charge 80% of the total capacity of the battery of the charging service use device 2000b.

In operation S684, the charging service use device 2000b may receive charging power from the electronic device 1000 and charge the built-in battery by using the received charging power.

In operation S686, when the charging power is received, the charging service use device 2000b may stop transmitting location information. In an embodiment, the charging service use device 2000b may stop the transmission of directional infrared signal including location information.

When the amount of charging power supply exceeds the threshold value (operation S690), the electronic device 1000 may return to the charging station. The electronic device 1000 may be docked onto the charging station to receive power from the charging station through the charging terminal 1212 (see FIG. 2) and charge the built-in battery by using the received power.

When the amount of charging power supply is below the threshold value, the electronic device 1000 may supply charging power to the charging service use device 2000b.

FIG. 7 is a flowchart illustrating a method of determining the charging schedule by the electronic device 1000 according to an embodiment of the present disclosure.

Operations S710 to S750 illustrated in FIG. 7 are specific steps of operation S320 of FIG. 3. Operation S710 illustrated in FIG. 7 may be performed after operation S310 of FIG. 3 is performed. Operation S330 of FIG. 3 may be performed after operation S710 illustrated in FIG. 7 is performed.

In operation S710, the electronic device 1000 may check whether the remaining capacity of the battery 1100 (see FIG. 2) exceeds the preset threshold value. The “threshold vale” refers to an amount of power by which the electronic device 1000 may supply charging power to charge a battery of a charging service use device and operate the driving module 1600 to return back to the charging station.

When the remaining capacity of the battery 1100 exceeds the threshold value (operation S720), the electronic device 1000 may identify current charging states of each of the at least one charging service use device. In an embodiment, the electronic device 1000 may identify information about a current remaining battery capacity, charging specifications, and an expected discharge time received from each of the at least one charging service use device.

In an embodiment, the electronic device 1000 may predict an expected discharge time of a battery of at least one charging service use device according to use history information of the at least one charging service use device. In an embodiment, the use history information may include at least one of a use start time, a use end time, a constant use state, and use time of each of the at least one charging service use device.

In operation S730, the electronic device 1000 may calculate a charging complete time for each of the at least one charging service use device. In an embodiment, the electronic device 1000 may calculate a charging complete time of each of the at least one charging service use device based on the charging specifications information received from the at least one charging service use device. In an embodiment, the charging specifications information may include information about at least one of a rated voltage for charging, a maximum allowable current, and a frequency of the charging service use device. The charging complete time may be calculated based on the charging speed according to the charging specifications information.

In operation S740, the electronic device 1000 may determine a charging order of the at least one charging service use device based on the calculation result. In an embodiment, the electronic device 1000 may compare the expected discharge time of the at least one charging service use device with the charging complete time calculated in operation S730 and determine the charging order such that a charging service use device of which the expected discharge time of battery is sooner than the charging complete time may be charged prior to other devices.

In an embodiment, the electronic device 1000 may determine the charging order to charge a charging service use device approaching a time point in which completion of charging is required, among the at least one charging service use device, prior to other devices. The electronic device 1000 may determine the charging order to first charge a device which is constantly used or performs a function of storing food, e.g., a refrigerator, before other charging service use devices.

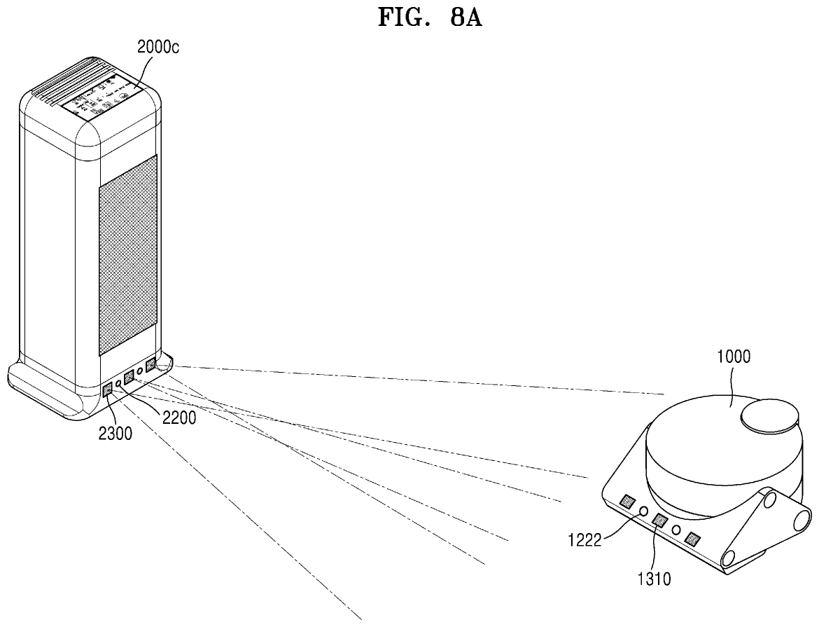

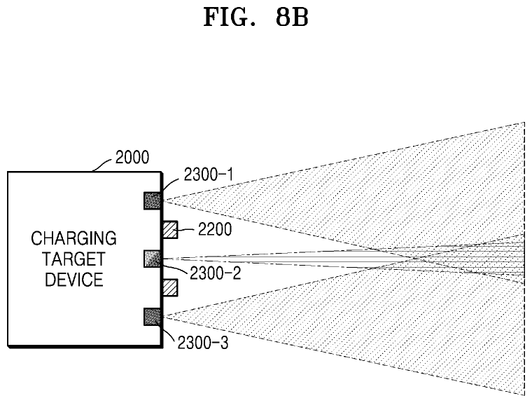

FIG. 8A is a diagram illustrating an embodiment in which the electronic device 1000 of the present disclosure identifies a location of a charging target device 2000c.

Referring to FIG. 8A, the charging target device 2000c may include the charging terminal 2200 and a plurality of infrared emitters 2300. The charging terminal 2200 may be formed to be exposed outside a housing of the charging target device 2000c. The charging terminal 2200 may include a plurality of terminals including conductors. The charging terminal 2200 may include, for example, copper (Cu); however, the present disclosure is not limited thereto. The charging terminal 2200 may be connected to the discharging terminal 1222 of the electronic device 1000 and receive power from the electronic device 1000 to charge a built-in battery.

The infrared emitter 2300 may send out an infrared signal to the outside of the charging target device 2000c. In an embodiment, the infrared emitter 2300 may include a plurality of infrared light-emitting elements. For example, the infrared emitter 2300 may include a plurality of IR LEDs; however, the present disclosure is not limited thereto.

FIG. 8B is a plan view of the charging terminal 2200 and infrared emitters (2300-1, 2300-2, and 2300-3) of the charging target device 2000c according to an embodiment of the present disclosure.

Referring to FIGS. 8A and 8B, the plurality of infrared emitters (2300-1, 2300-2, and 2300-3) may each include a plurality of infrared light-emitting elements spaced apart from each other at equal intervals. A plurality of charging terminals 2200 may be arranged between the plurality of infrared emitters (2300-1, 2300-2, and 2300-3).

The plurality of infrared emitters (2300-1, 2300-2, and 2300-3) may respectively transmit directional infrared signals having different frequencies and codes from each other.

The plurality of infrared emitters (2300-1, 2300-2, and 2300-3) may transmit infrared signals at different angles from each other. In an embodiment, an infrared signal sent by a second infrared emitter 2300-2 may be a front signal, an infrared signal sent by a first infrared emitter 2300-1 may be a left signal, and an infrared signal sent by a third infrared emitter 2300-3 may be a right signal. The infrared signal transmitted by the first infrared emitter 2300-1 and the infrared signal transmitted by the third infrared emitter 2300-3 may be symmetrical with each other with respect to the front signal; however, the present disclosure is not limited thereto.

Referring back to FIG. 8A, the electronic device 1000 may include the discharging terminal 1222 and the infrared sensor 1310.

The discharging terminal 1222 may be formed to be exposed outside the housing of the electronic device 1000, and may supply power stored in the battery 1100 (see FIG. 2) by electrically and/or physically connecting to the charging terminal 2200 of the charging target device 2000c.

The infrared sensor 1310 may receive an infrared signal transmitted from the charging target device 2000c. The infrared sensor 1310 may sense an intensity and a transmission angle of an infrared signal. In an embodiment, the infrared sensor 1310 may identify a code of an infrared signal.

The electronic device 1000 may identify a location of the charging target device 2000c based on at least one of an intensity, an angle, and a code of the infrared signal sensed by using the infrared sensor 1310.

The electronic device 1000 may determine a travel route to move towards the identified location of the charging target device 2000c. The electronic device 1000 may move towards the location of the charging target device 2000c along the travel route. The electronic device 1000 may calculate an angle between the charging target device 2000c and the electronic device 1000 based on an angle of the infrared signal sensed by the infrared sensor 1310. The electronic device 1000 may rotate and drive to form an angle of 0° with the charging target device 2000c and may connect the discharging terminal 1222 to the charging terminal 2200 of the charging target device 2000c through rotation. The electronic device 1000 may discharge the battery and supply power stored in the battery to the charging terminal 2200 of the charging target device 2000c through the discharging terminal 1222.

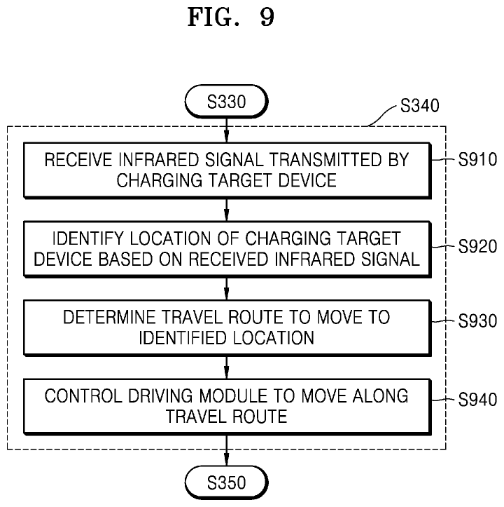

FIG. 9 is a flowchart illustrating how the electronic device 1000 moves towards a location of the charging target device 2000c (see FIG. 8A).

Operations S910 to S940 illustrated in FIG. 9 are specific steps of operation S340 of FIG. 3. Operation S910 illustrated in FIG. 9 may be performed after operation S330 of FIG. 3 is performed. Operation S350 of FIG. 3 may be performed after operation S940 illustrated in FIG. 9 is performed.

In operation S910, the electronic device 1000 may receive an infrared signal sent by the charging target device 2000c. In an embodiment, the electronic device 1000 may receive an infrared signal sent by the infrared emitter 2300 (see FIG. 8A) included in the charging target device 2000c by using the infrared sensor 1310 (see FIG. 8A). In an embodiment, the electronic device 1000 may sense at least one of a signal intensity, a frequency, a code, and an angle of each of a plurality of infrared signals transmitted from the charging target device 2000c by using the infrared sensor 1310.

In operation S920, the electronic device 1000 may identify a location of the charging target device 2000c based on the received infrared signal. In an embodiment, the electronic device 1000 may identify a location of the charging target device 2000c based on at least one of a signal intensity, a frequency, a code, and an angle of each of the plurality of infrared signal sensed through the infrared sensor 1310.

In operation S930, the electronic device 1000 may determine a travel route to move towards the identified location of the charging target device 2000c. In an embodiment, the electronic device 1000 may identify a location of the charging target device 2000c on a 3D map of the interior space and generate a travel route to move towards the location of the charging target device 2000c by using information about surrounding objects and the 3D map. In an embodiment, the electronic device 1000 may generate a 3D map by scanning the entire space in which the electronic device 1000 is deployed by using the simultaneous localization and mapping (SLAM) technology and by using the 3D map, generate a travel route to move towards the location of the charging target device 2000c.

In operation S940, the electronic device 1000 may control the driving module 1600 to move along the travel route.

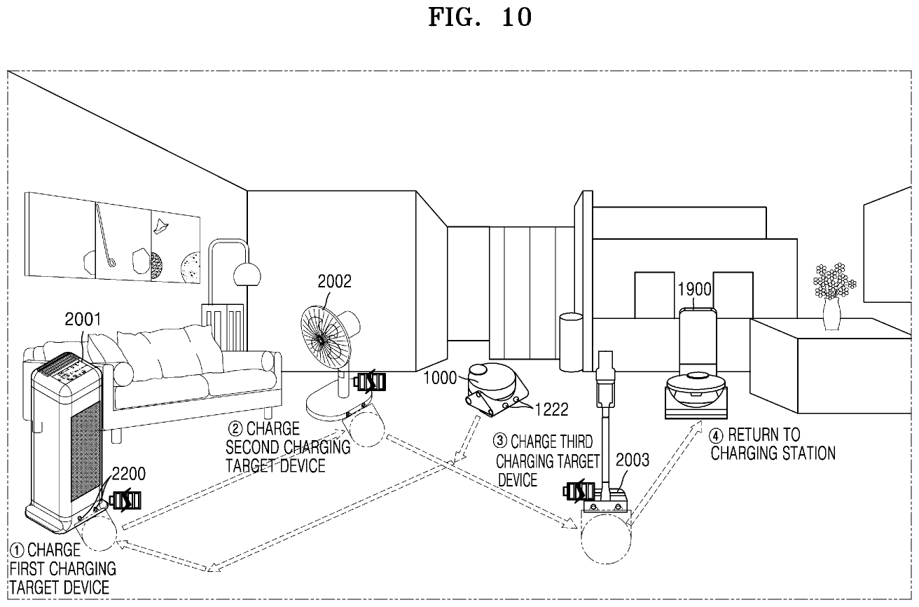

FIG. 10 is a diagram illustrating an embodiment in which the electronic device 1000 of the present disclosure returns to a charging station 1900 after charging charging target devices 2001, 2002, 2003, and 2004 according to the charging schedule.

Referring to FIG. 10, the electronic device 1000 may charge the plurality of charging target devices 2001, 2002, 2003, and 2004 according to the charging time and charging order determined based on the charging schedule. In an embodiment illustrated in FIG. 10, the electronic device 1000 may move towards a location of a first charging target device 2001 at a charging time determined based on the charging schedule and then supply charging power to the first charging target device 2001. When it is determined that the battery of the first charging target device 2001 is charged to a preset target value, the electronic device 1000 may move towards the location of the second charging target device 2002 to charge the second charging target device 2002 according to the charging order determined based on the charging schedule. The electronic device 1000 may supply charging power to the second charging target device 2002.

By using the method described above, the electronic device 1000 may move and supply charging power to the first charging target device 2001, the second charging target device 2002, the third charging target device 2003, and the fourth charging target device 2004 sequentially according to the charging schedule. When it is determined that the fourth charging target device 2004 is charged to a preset target value, the electronic device 1000 may move towards the charging station 1900. The electronic device 1000 may connect to the charging station 1900 and charge the built-in battery.

FIG. 11 is a diagram illustrating an embodiment in which the electronic device 1000 of the present disclosure determines a charging schedule according to electric charges per time periods.

Referring to the graph showing unit price for electricity in FIG. 11, the unit price for 1 KWh varies according to time period. Referring to a graph of unit price for electricity 110, the electric charge per 1 KWh is about 100 won during late night hours, for example, from a first time point t1 (e.g., 2 am) to a second time point t2 (e.g., 8 am), the electric charge per 1 KWh is about 150 won during daytime hours, for example, from the second time point t2 to a third time point t3 (e.g., 5 pm), and the electric charge per 1 KWh is about 120 won during nighttime hours, for example, from the third time point t3 to a fourth time point t4 (e.g., 12 am). The electric charges per time period shown in the graph of unit price for electricity 110 in FIG. 11 are merely an example, and the electric charges may vary according to seasons, regions, policies, and are not limited to the description of FIG. 11.

The electronic device 1000 may control charging/discharging of the built-in battery according to the electric charges per time period. In an embodiment, the electronic device 1000 may connect to the charging station 1900 (see FIG. 10) during late night hours to which a relatively lower electric rate is applied, e.g., between the first time point t₁ and the second time point t₂ and charge the built-in battery. The electronic device 1000 may supply charging power for charging the charging service use device 2000 by discharging the built-in battery according to a charging request signal during daytime hours and nighttime hours, e.g., between the second time point t₂ and the fourth time point t₄. The charging service use device 2000 may charge the battery by using the charging power received from the electronic device 1000.

In an embodiment illustrated in FIG. 11, the electronic device 1000 may charge the built-in battery through the charging station during the late night hours to which a relatively low electric rate is applied in comparison with the daytime rate or the nighttime rate, and supply the power stored in the built-in battery to the charging service use device 2000 as charging power to provide electric charge-cutting effect.

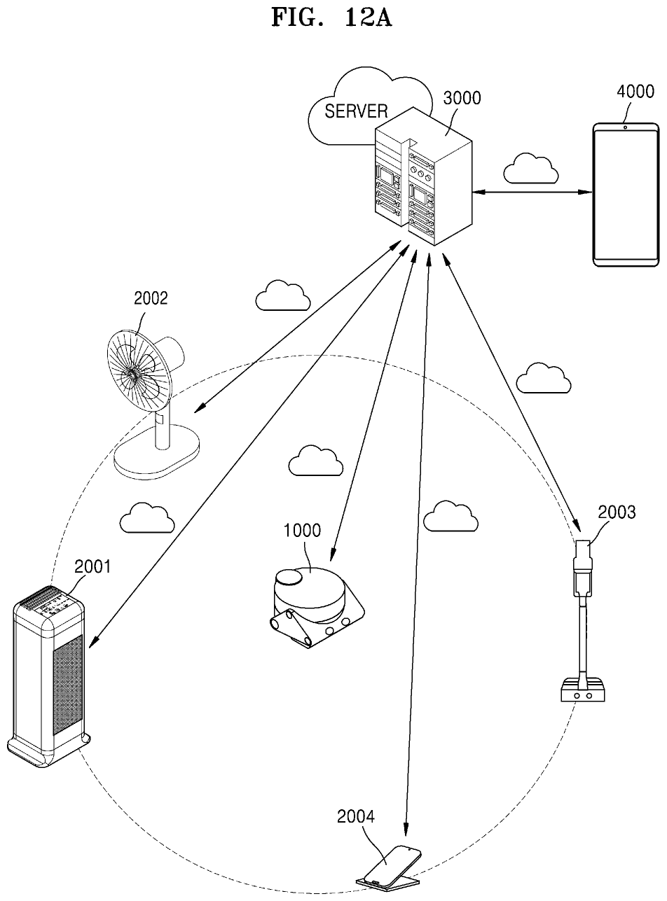

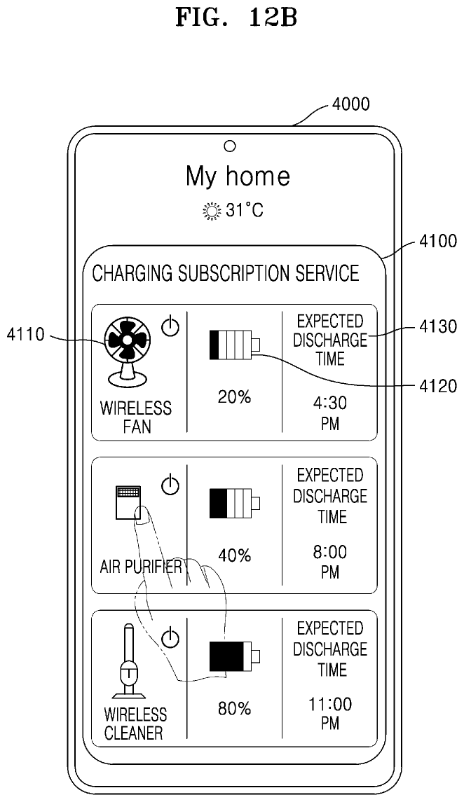

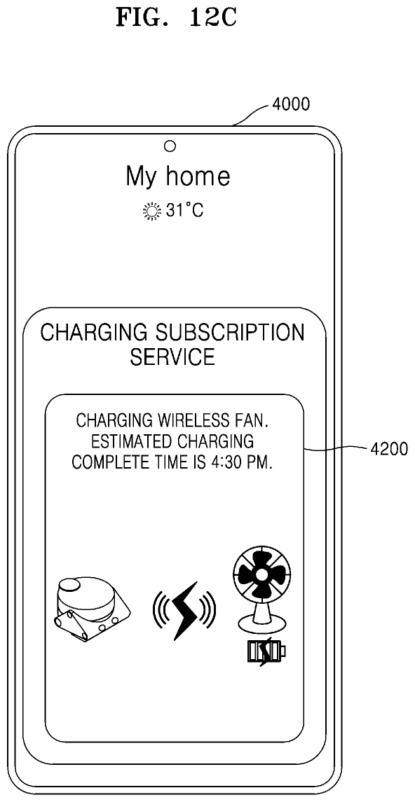

FIG. 12A is a diagram illustrating an embodiment in which the electronic device 1000 is connected to the plurality of charging service use devices (2001, 2002, 2003, and 2004), a server 3000, and a display device 4000 according to an embodiment of the present disclosure.

Referring to FIG. 12A, the electronic device 1000, the plurality of charging service use devices (2001, 2002, 2003, and 2004), the server 3000, and the display device 4000 may be connected to each other through wired or wireless communication and perform data communication with each other. In an embodiment, the electronic device 1000, the plurality of charging service use devices 2001, 2002, 2003, and 2004, and the display device 4000 may be connected to the server 3000 through a wireless communication network. The electronic device 1000, the plurality of charging service use devices 2001, 2002, 2003, and 2004, and the display device 4000 may be connected through a short-range communication network including at least one of WiFi, WiFi Direct, Bluetooth, Bluetooth low energy (BLE), Zigbee, ultra wideband (UWB), and near field communication (NFC).

The plurality of charging service use devices 2001, 2002, 2003, and 2004 may be a device logged in through the same user account as the electronic device 1000 and preregistered at the server 3000.

The server 3000 may be an Internet of Things (IoT) server storing information about the electronic device 1000 and the plurality of charging service use devices 2001, 2002, 2003, and 2004 preregistered at the user account. The server 3000 may receive log-in user account information and device identification information (e.g., device ID) from each of the electronic device 1000 and the plurality of charging service use devices 2001, 2002, 2003, and 2004.

In an embodiment, the server 3000 may receive information about the remaining capacity of the built-in battery from the electronic device 1000. In an embodiment, the server 3000 may receive charging state information including at least one of a current remaining battery capacity, charging specifications, and an expected discharge time from each of the plurality of charging service use devices 2001, 2002, 2003, and 2004.

The server 3000 may generate a charging schedule determining charging time and the charging order of the plurality of charging service use devices 2001, 2002, 2003, and 2004 based on the received remaining battery capacity of the electronic device 1000 and the charging state information of each of the plurality of charging service use devices 2001, 2002, 2003, and 2004. In an embodiment, the server 3000 may transmit the information about the charging schedule to the electronic device 1000.

In an embodiment, the electronic device 1000 may determine a charging target device from among the plurality of charging service use devices 2001, 2002, 2003, and 2004 based on the charging schedule received from the server 3000. However, the present disclosure is not limited thereto, and in another embodiment, the server 3000 may determine a charging target device based on the charging schedule and transmit information about the determined charging target device to the electronic device 1000.

The electronic device 1000 may move towards a location of the determined charging target device and supply charging power by connecting to the charging terminal of the charging target device.

The display device 4000 may be a device for executing a particular application provided by the server 3000. The display device 4000 may be a user mobile terminal, a user wearable device, a refrigerator including a display, a TV, a desktop, a laptop, etc.; however, the present disclosure is not limited thereto. As for FIGS. 12A to 12C, the case where the display device 4000 is a mobile terminal is described for convenience in explanation.

The display device 4000 may be logged in by using the same user account as the electronic device 1000 and the plurality of charging service use devices (2001, 2002, 2003, and 2004) and may be connected to the server 3000. In an embodiment, the display device 4000 may execute an application provided by the server 3000 and display a user interface (UI) showing a list and charging state information of the plurality of charging service use devices 2001, 2002, 2003, and 2004 through the application. The display device 4000 will be further described in detail in relation to FIGS. 12B and 12C.

FIG. 12B is a diagram illustrating an embodiment in which the display device 4000 of the present disclosure displays a charging subscription service UI 4100 by executing an application.

Referring to FIG. 12B, the display device 4000 may execute a charging subscription service application. The “charging subscription service application” may be an application displaying a charging service use device list and charging state information of each of the plurality of charging service use devices and may be provided by the server 3000 (see FIG. 12A). The display device 4000 may display the charging subscription service UI 4100 showing a list of a plurality of charging service use devices, a remaining battery capacity, and information about an expected discharge time by executing the charging subscription service application.

The charging subscription service UI 4100 may include a charging service use device list UI 4110, a battery UI 4120, and an expected discharge time UI 4130.

The charging service use device list UI 4110 may include device information thumbnail images of the plurality of charging service use devices.

The battery UI 4120 may include a graphic UI showing remaining battery capacity of each of the plurality of charging service use devices.

The expected discharge time UI 4130 may display an expected discharge time of battery of each of the plurality of charging service use devices.

An order shown in the charging service use device list UI 4110 may indicate a charging order of the plurality of charging service use devices. Referring to the charging service use device list UI 4110 illustrated in FIG. 12B, the wireless fan, the air purifier, and the wireless cleaner may be charged in this stated order. The electronic device 1000 may charge the plurality of charging service use devices according to the charging order displayed by the display device 4000.

However, the present disclosure is not limited thereto, and the electronic device 1000 may determine the charging order based on the user input received through the display device 4000. In an embodiment, the display device 4000 may receive a user input selecting at least one device from among the plurality of charging service use devices displayed through the charging subscription service UI 4100 and determine a device selected based on the user input as a charging target device. In an embodiment illustrated in FIG. 12B, the display device 4000 may receive a user touch input selecting the air purifier and determine the air purifier as a charging target device based on the received touch input. The display device 4000 may transmit information about the determined charging target device to the server 3000 (see FIG. 12A). The server 3000 may transmit the information about the charging target device to the electronic device 1000 (see FIG. 12A). The electronic device 1000 may supply charging power to the charging target device based on the information about the charging target device received from the server 3000.

The display device 4000 according to an embodiment illustrated in FIG. 12B may display the charging subscription service UI 4100 such that the charging order, a remaining battery capacity, and an expected discharge time of the plurality of charging service use devices may be easily recognized by a user. In addition, as the display device 4000 allows a user to select a device to be charged and first charge the selected device instead of charging devices according to a charging order automatically determined based on the charging state information, user convenience may be improved.

FIG. 12C is a diagram illustrating an embodiment in which the display device 4000 displays a charging UI 4200 by executing a charging subscription service application according to an embodiment of the present disclosure.

Referring to FIG. 12C, the display device 4000 may display the charging UI 4200 by executing the charging subscription service application. The charging UI 4200 may display a thumbnail image of a charging target device currently being charged by the electronic device 1000 and battery charging information of the charging target device.

The user may intuitively identify the charging target device currently being charged and the charging amount of the charging target device through the charging UI 4200 displayed by the display device 4000, which may leads to improved user convenience.

A program executed by the electronic device 1000 described herein may be implemented by a hardware component, a software components, and/or a combination of a hardware component and a software component. The program may be executed by any system capable of executing computer-readable instructions.

The software may include a computer program, a code, and an instruction, or a combination of one or more of the foregoing, and may configure the processing unit to operate in a desired manner or command independently or collectively the processing unit.

The software may be implemented by computer program including instructions stored in computer-readable storage media. The computer-readable storage media may include, for example, a magnetic storage medium (e.g., read-only memory (ROM), random-access memory (RAM), floppy disk, hard disk, etc.) and optical reading medium (e.g., CD-ROM, digital versatile disk (DVD), etc.) The computer-readable storage media may be distributed among computer systems connected by networks and computer-readable codes may be stored and executed by distribution method. The medium may be readable by a computer, stored in a memory, and executable by a processor.

The computer-readable storage medium may be provided in the form of a non-transitory storage medium. The term “non-transitory” means that the storage medium does not include signals and is tangible, and this does not distinguish between semi-permanent and transitory storage of data in the storage medium. For example, the “non-transitory storage medium” may include a buffer in which data is temporarily stored.

In addition, the program according to the aforementioned embodiments of the present disclosure may be included and provided in computer program product. The computer program product is a commodity and may be traded between a seller and a buyer.

The computer program product may include a software program and a computer-readable storage medium storing the software program. For example, the computer program may include a software program product electronically distributed through a manufacturer of an electronic device or an electronic market (e.g., Google play store, app store, etc.), for example, a downloadable application. For electronic distribution, at least a part of the software program may be stored in a storage medium or temporarily generated. In this case, the storage medium may be a server of manufacturer of the electronic device 1000, a server of an electronic market, or a relay server temporarily storing the software program.

The computer program product may include a storage medium of the server 3000 or a storage medium of the electronic device in a system including the electronic device 1000, the server 3000 (see FIG. 12A), and other electronic devices (e.g., the display device 4000 (see FIG. 12A)). Alternatively, when there is a third device (e.g., the display device 4000) connected with the electronic device 1000, the computer program product may include a storage medium of the third device. The computer program product may include a software program transmitted to another electronic device or a third device from the electronic device 1000 or transmitted from a third device to another electronic device.

In this case, one of the electronic device 1000, another electronic device, and the third device may execute the computer program product and perform methods according to the aforementioned embodiments. Alternatively, two or more of the electronic device 1000, another electronic device, and the third device may execute the computer program product and perform methods according to the aforementioned embodiments in a distributed manner.

For example, the electronic device 1000 may execute the computer program product stored in the memory 1500 (see FIG. 2) and control another electronic device connected to the electronic device 1000 to perform the methods according to the aforementioned embodiments.

In another example, the third device may execute the computer program product and control another electronic device connected to the third device to perform the methods according to the aforementioned embodiments.

When the third device performs the computer program product, the third device may download the computer program product from the electronic device 1000, and then perform the downloaded computer program product. Alternatively, the third device may execute a pro-loaded computer program product and perform the methods according to the aforementioned embodiments.

While embodiments of the present disclosure have been particularly shown and described with reference to the accompanying drawings, various modifications and changes may be made from the descriptions by one of skill in the art. For example, proper results may be achieved even when the operations described above may be performed differently from the described order, and/or the aforementioned components, such as computer systems, modules, etc. are coupled or combined in other forms, replaced or substituted with other components or equivalents.

1. An electronic device configured to provide a charging service, the electronic device comprising:
a driving module;
a battery;
a discharging interface configured to supply power to at least one charging service use device by discharging power stored in the battery;
a communication interface configured to perform data transmission and reception with the at least one charging service use device by using a short-range communication network;
a memory storing at least one instruction; and
at least one processor configured to execute the at least one instruction to:
control the communication interface to receive, from the at least one charging service use device, charging state information including at least one of device identification information, charging specifications, a current remaining battery capacity, and an expected discharge time,
generate a charging schedule for supplying charging power to the at least one charging service use device based on a remaining capacity of the battery and the received charging state information of the at least one charging service use device,
determine a charging target device from among the at least one charging service use device based on the charging schedule,
control the driving module to move towards a location of the determined charging target device, and
charge the charging target device by supplying power stored in the battery to the charging target device through connection with a charging terminal of the charging target device.

2. The electronic device of claim 1, wherein the at least one processor is further configured to execute the at least one instruction to:
through the communication interface, receive a signal for requesting charging power supply from the at least one charging service request device and in response to the signal for requesting charging power supply being received, transmit a signal for requesting current battery charging state information and charging specifications information to the at least one charging service request device, and
receive at least one of device identification information, current battery charging state information, and charging specifications information from the at least one charging service request device.

3. The electronic device of claim 2, further comprising:
a data storage storing a charging service use device list including information related to at least one of device identification information, battery capacity, and charging specifications information of the at least one charging service use device,
wherein the at least one processor is further configured to execute the at least one instruction to store information received from the at least one charging service request device in the charging service use device list.

4. The electronic device of claim 1, wherein the at least one processor is further configured to execute the at least one instruction to:
receive use history information including at least one of a use start time, a use end time, a constant use state, and use time from the at least one charging service use device through the communication interface, and
determine a charging order of the at least one charging service use device based on the expected discharge time estimated according to the use history information of each of the at least one charging service use device.

5. The electronic device of claim 1, further comprising:
an infrared sensor configured to receive an infrared signal transmitted by the charging target device,
wherein the at least one processor is further configured to execute the at least one instruction to:
identify a location of the charging target device based on an infrared signal received through the infrared sensor and determine a travel route to move towards the identified location, and
control the driving module to move along the determined travel route.

6. The electronic device of claim 1, wherein the at least one processor is further configured to execute the at least one instructions to:
determine whether a first charging target device is charged to a preset target value,
control the driving module to move towards a location of a second charging target device according to a charging order determined by the charging schedule, and
control the discharging interface to charge the second charging target device by discharging the battery.

7. The electronic device of claim 1, further comprising:
a converter configured to convert charging power,
wherein the at least one processor is further configured to execute the at least one instruction to:
control the converter to convert power supplied from the battery based on a rated voltage, a maximum allowable current, and a frequency included in charging specifications information received from the charging target device, and
control the discharging interface to supply the converted power to the charging target device.

8. The electronic device of claim 1, wherein the at least one processor is further configured to execute the at least one instruction to:
determine whether the charging target device is charged over a preset threshold value and control the discharging interface to discontinue charging power supply based on a result of the determination, and
control the driving module to move towards a charging station to charge the battery.

9. A method operated by an electronic device, the method comprising:
receiving, from at least one charging service use device, charging state information including at least one from among device identification information, charging specifications, a current remaining battery capacity, and an expected discharge time;
generating a charging schedule to determine a time and a charging order for supplying charging power to the at least one charging service use device based on a remaining capacity of a built-in battery of the electronic device and the received charging state information;
determining a charging target device from among the at least one charging service use device based on the charging schedule;
moving towards a location of the determined charging target device; and
charging the charging target device by supplying power stored in the battery to the charging target device through connection with a charging terminal of the charging target device.

10. The method of claim 9, further comprising:
by the electronic device,
receiving a signal for requesting charging power supply from at least one charging service request device by using a short-range communication network;
in response to the signal for requesting charging power supply being received, transmitting a signal for requesting current battery charging state information and charging specifications information to the at least one charging service request device; and
receiving at least one of device identification information, current battery charging state information, and charging specifications information from the at least one charging service request device.

11. The method of claim 10, further comprising:
by the electronic device,
storing information received from the at least one charging service request device in a charging service use device list.

12. The method of claim 9, wherein
the receiving of the charging state information comprises receiving use history information including at least one of a use start time, a use end time, a constant use state, and use time from the at least one charging service use device, and
the generating of the charging schedule comprises determining a charging order of the at least one charging service use device based on the expected discharge time estimated according to the use history information of each of the at least one charging service use device.

13. The method of claim 9, wherein the moving towards a location of the charging target device comprises:
receiving an infrared signal transmitted by the determined charging target device;
identifying a location of the charging target device based on the received infrared signal;
determining a travel route to move towards the identified location; and
controlling a driving module to move along the determined travel route.

14. The method of claim 9, wherein the charging of the charging target device comprises, after charging a first charging target device to a preset target value, moving to a location of a second charging target device according to a charging order determined by the charging schedule and charging the second charging target device.

15. A computer program product comprising a non-transitory computer-readable storage medium storing instructions that are executable by at least one processor to perform a method including:
an operation of receiving, from at least one charging service use device, charging state information including at least one from among device identification information, charging specifications, a current remaining battery capacity, and an expected discharge time;
an operation of generating a charging schedule to determine a time and a charging order for supplying charging power to the at least one charging service use device based on a remaining capacity of a built-in battery of an electronic device and the received charging state information;
an operation of determining a charging target device from among the at least one charging service use device based on the charging schedule;
an operation of controlling a driving module of the electronic device to move towards a location of the determined charging target device; and
an operation of charging the charging target device by supplying power stored in the battery to the charging target device through connection with a charging terminal of the charging target device.
wherein the electronic device includes instructions related to a method of charging the charging service use device.
